(19) United States
(12) Patent Application Publication
(10) Pub. No.: US 2021/0382807 A1
(43) Pub. Date: Dec. 9, 2021

(54) MACHINE LEARNING BASED APPLICATION SIZING ENGINE FOR INTELLIGENT INFRASTRUCTURE ORCHESTRATION

(71) Applicants: Shishir R. Rao, San Jose, CA (US); Ravindra JN Rao, San Jose, CA (US)

(72) Inventors: Shishir R. Rao, San Jose, CA (US); Ravindra JN Rao, San Jose, CA (US)

(21) Appl. No.: 17/329,046

(22) Filed: May 24, 2021

Related U.S. Application Data
(60) Provisional application No. 63/029,264, filed on May 22, 2020.

(51) Int. Cl. G06F 11/34; G06F 11/30; G06N 20/00

(52) U.S. Cl. CPC G06F 11/3442; G06N 20/00; G06F 11/3006; G06F 11/3433

(57) ABSTRACT

This disclosure provides an apparatus, a method and a nontransitory storage medium having computer readable instructions for sizing infrastructure needed for an application as a service.

### CROSS-REFERENCE TO RELATED APPLICATION

This application claims the benefit of U.S. Provisional Patent Application Serial No. 63/029,264 filed on May 22, 2020 under 35 U.S.C. § 119, the entire disclosure of which is incorporated herein by reference.

### TECHNICAL FIELD

This invention relates to business application infrastructure and, more specifically, to facilitate the service provisioning and delivery among cloud service and data center service customers an appropriately sized capacity of the infrastructure components with each component associated with its Key Performance Indicators (KPIs) based on the Intent of the end user.

### BACKGROUND

Cloud computing refers to the use of dynamically scalable computing resources for providing Information Technology (IT) infrastructure for business applications. The computing resources, often referred to as a “cloud,” provide one or more services to users. These services may be categorized according to service types, which may include for examples, applications/software, platforms, infrastructure, virtualization, and servers and data storage. The names of service types are often prepended to the phrase “as-a-Service” such that the delivery of applications/software and infrastructure, as examples, may be referred to as Software-as-a-Service (SaaS), Platform-as-a-Service (PaaS) and Infrastructure as a Service (IaaS).

The term “Infrastructure as a Service” or more simply “IaaS” refers not only to infrastructure services provided by an Infrastructure as a Service provider, but also to a form of service provisioning in which cloud customers contract with IaaS service providers for the online delivery of services provided by the cloud. Cloud service providers manage a public, private, or hybrid cloud infrastructure to facilitate the online delivery of cloud services to one or more cloud customers.

### SUMMARY

This disclosure provides a method of sizing the infrastructure for an application as a service, comprising:

receiving the performance, availability, reliability and security information associated with a request for service;

determining an amount of infrastructure and its corresponding Key Performance Indicators (KPIs) to provide for the service based on an empirical model; and

outputting the amount of infrastructure to a service orchestration system.

Embodiments include:

The method further comprising

receiving first information associated with the key performance indicators (KPI) of the service's infrastructure components;

predicting the performance of the infrastructure based on the KPI; receiving second information associated with observed performance of the infrastructure;

comparing the predicted performance based on the KPI with the observed performance;

converting the observed performance, availability, reliability and security parameters of the infrastructure into homogenized space vectors for a machine learning algorithm; and

updating the weights of the KPI and performance characteristics using the machine learning algorithm.

The method further comprising

determining a sizing solution for an amount of infrastructure to provide the service based on the updated weights of the KPI and performance characteristics; and

outputting the sizing solution along with the updated KPIs to the service orchestration system.

This disclosure also provides an apparatus for sizing infrastructure for an application as a service, comprising:

a memory; and

at least one processor coupled to the memory, the processor configured to: receive information associated with a request for service;

determine an amount of infrastructure to provide the service based on an empirical model;

output the amount of infrastructure to a service orchestration systems.

Embodiments include:

The apparatus wherein the processor is further configured to

receive first information associated with the key performance indicators (KPI) of the infrastructure components;

predict the performance of the infrastructure based on the KPI;

receive second information associated with observed performance of the infrastructure;

compare the predicted performance based on the KPI with the observed performance;

convert the observed performance, availability, reliability and security parameters of the infrastructure into homogenized space vectors for a machine learning algorithm; and

update the weights of the KPI and performance characteristics using the machine learning algorithm.

The apparatus wherein the processor is further configured to

determine a sizing solution for an amount of infrastructure to provide the service based on the updated weights of the KPI and performance characteristics;

output the sizing solution to the service orchestration system.

This disclosure also provides a non-transitory computer readable medium having computer readable instructions stored thereon, that when executed by a computer cause at least one processor to,

receive information associated with a request for service;

determine an amount of infrastructure to provide the service based on an empirical model; and

output the amount of infrastructure to a service orchestration system.

Embodiments include:

The non-transitory computer readable medium wherein the computer readable instructions further cause at least one processor to

receive first information associated with the key performance indicators (KPI) of the infrastructure components;

predict the performance of the infrastructure based on the KPI;

receive second information associated with observed performance of the infrastructure;

compare the predicted performance based on the KPI with the observed performance;

convert the observed performance, availability, reliability and security parameters of the infrastructure into homogenized space vectors for a machine learning algorithm; and

update the weights of the KPI and performance characteristics using the machine learning algorithm.

The non-transitory computer readable medium wherein the computer readable instructions further cause at least one processor to

determine a sizing solution for an amount of infrastructure to provide the service based on the updated weights of the KPI and performance characteristics; and

output the sizing solution to a service orchestration system.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows the architecture of the Application Service Provisioning System according to exemplary embodiments of the disclosure.

FIGS. 2a and 2B show the user input portal according to exemplary embodiments of the disclosure.

FIG. 3 shows the Service Orchestration System according to exemplary embodiments of the disclosure.

FIG. 4 shows aspects of the infrastructure in the topology of the infrastructure as a service according to exemplary embodiments of the disclosed subject matter.

FIG. 5 shows aspects of the Application Sizing Engine according to exemplary embodiments of the disclosed subject matter.

FIG. 6A shows aspects of the ML based Resource Optimizer operating in a Learning Mode according to exemplary embodiments of the disclosed subject matter.

FIG. 6B shows aspects of the ML based Resource Optimizer operating in a Predict Mode according to exemplary embodiments of the disclosed subject matter.

FIG. 6C shows aspects of the Capacity and KPI Remediation according to exemplary embodiments of the disclosed subject matter.

FIG. 7 shows aspects of the input portal form for a given Application type according to exemplary embodiments of the disclosed subject matter.

FIG. 7a shows aspects of the workflow from the input portal to the infrastructure according to exemplary embodiments of the disclosed subject matter.

FIG. 8 depicts the workflow of how a particular Application Type will be delivered for the very first time on the infrastructure according to exemplary embodiments of the disclosed subject matter.

FIG. 9 depicts the workflow of the ASE in learning mode according to exemplary embodiments of the disclosed subject matter.

FIG. 10 depicts the workflow of the ASE's ML algorithms in the predict mode, according to exemplary embodiments of the disclosed subject matter.

FIG. 11 depicts the workflow of the ASE according to exemplary embodiments of the disclosed subject matter.

### BRIEF DEFINITIONS

P.A.R. S. characteristics: Performance, Availability, Reliability, and Security characteristics include the following parameters.

Performance characteristics: parameters upon which the application performance is measured. Specifically: Transactions per Second (TPS), number of concurrent transactions, latency per transaction, etc.

Availability characteristics: measurement of time that defines the availability of the application for a user. Specifically: degree of availability may be defined by the number of “9's” in percentage and Recover Point Objective (RPO). Number of “9's” e.g. “3 9's” means 99.9% availability of said application, “4 9's” means 99.99% availability of said application and so on. Also, there is the measurement of RPO, measured in seconds, which means: in the event that the service is lost, this a measurement in seconds of the maximal allowance of time lag for which the application will allow.

Reliability Characteristics: a measure of reliability which is binary and involves allocating/not allocating “(n+1)” resources for the application infrastructure.

Security Characteristics: the parameters involved for delivering the required level of security for said infrastructure. Specifically, the level of privacy of infrastructure in terms of infrastructure resources and hardware.

Input Output Operations Per Second (TOPS): The number of input and output operations per second, one of the performance parameters for disk storage systems.

Key Performance Indicators (KPI): performance characteristics of components (storage, network, memory, and computational components). Specifically these may be measured in percentage utilized of CPU, percentage utilized of memory components, latency and TOPS of storage components, maximum bandwidth required and error rate of network components, etc.

Service Level Agreement (SLA)—P.A.R. S. characteristics agreed upon by user and service provider.

Capacity—The required amount of classified resource (Compute, Storage, Network, etc.) needed to deliver the service.

### DETAILED DESCRIPTION OF ILLUSTRATED EMBODIMENTS

The following detailed description of example implementations refers to the accompanying drawings. The same reference numbers in different drawings may identify the same or similar elements.

When a user, henceforth referred to as U requires compute, memory, storage, and network services to host and maintain a certain business application, U will request a service provider to accurately provision the said Infrastructure as a Service. The Application Sizing Engine, henceforth referred to as ASE, aims to calculate the amount of individual components and provision U with components (e.g. compute, memory, storage, and network components) to host said application adhering to SLA between U and Service Provider at all times.

This document in general describes the Machine Learning (ML) based Application Sizing Engine in detail and other intelligent infrastructure orchestration components in an application service provisioning system. The specific component discussed in depth in this document is the Application Sizing Engine where the said module will facilitate the provisioning of appropriate infrastructure based on the intent provided by the user. This module will make the calculations for successfully provisioning the Infrastructure as a Service for the user's application. This Application Sizing Engine as described herein will, as a result, facilitate provisioning a business-level service according to well-defined service policies, quality of service, service level agreements, and costs, and further according to a service topology for the business-level service.

The Application Sizing Engine (ASE) comprises a software module that will size the appropriate infrastructure components required to accurately provision the application to satisfy the intent of the application and will communicate with an Infrastructure as a Service Orchestration System to deliver the requisite application infrastructure. The ASE achieves this by first delivering the capacity and Key Performance Indicators (KPIs) of the individual components based on the Application Service Level Agreement (SLA) provided by the user using empirical data. In this time, the ASE will train or teach the Machine Learning (ML) module to learn associations between the infrastructure components, KPI, and finally the Performance characteristics. After validating the ML module's propensity to learn these relationships, the ASE will leverage this trained module to ensure the SLA intended for the application is adhered to by training the data model based out of the current infrastructure and later correcting the predicted capacity and KPI of the component(s) if necessary.

An Application is a computer program or a group of programs designed to assist in performing a business activity. The application is executed on one of more infrastructure components and the capacity or the number of these components will depend on the complexity of the application. For eg. An online transaction database (OLTP), a data warehousing database (DW), a web server or a messaging server are different application types that can be executed on the infrastructure.

The SLA differs from application to application and business to business. The SLA is a combination of the PARS parameters defined above. For eg. The SLA of an OLTP database could be;
a. Performance: 2500 Transactions per second, less than 2 Secs latency per transaction and 500 concurrent transactions
b. Availability: 4-9s (Downtime: 52 mins, 36 secs per year)
c. Reliability: Clustered servers for redundancy
d. Security: Independent hardware.

For a web server the SLA definition will be different as follows:
a. Performance: Load Time less than 1.5 Secs, Speed Index of less than 2500 ms
b. Availability: 5-9s (Downtime of 25 mins 30 secs per year)
c. Reliability None
d. Security: Shared hardware.

While the infrastructure service provider, henceforth referred to as ISP will provision the service with components that aim to meet the requirements of said application, the ASE aims to accurately size the individual components for said application that meet (or exceed) SLA requirements. Initially obtaining the application type and corresponding SLA requirements (PARS parameters) for an application from the Service Orchestration Systems, which is a software module that provides the infrastructure sizing and minimum thresholds for KPIs for the individual infrastructure components to meet SLA requirements. Additionally in runtime, the module will autonomously (using machine learning) resize the infrastructure for said application based on the service analytics and assurances data provided by the Service Analytics and Assurances Systems within the Service Orchestration Systems.

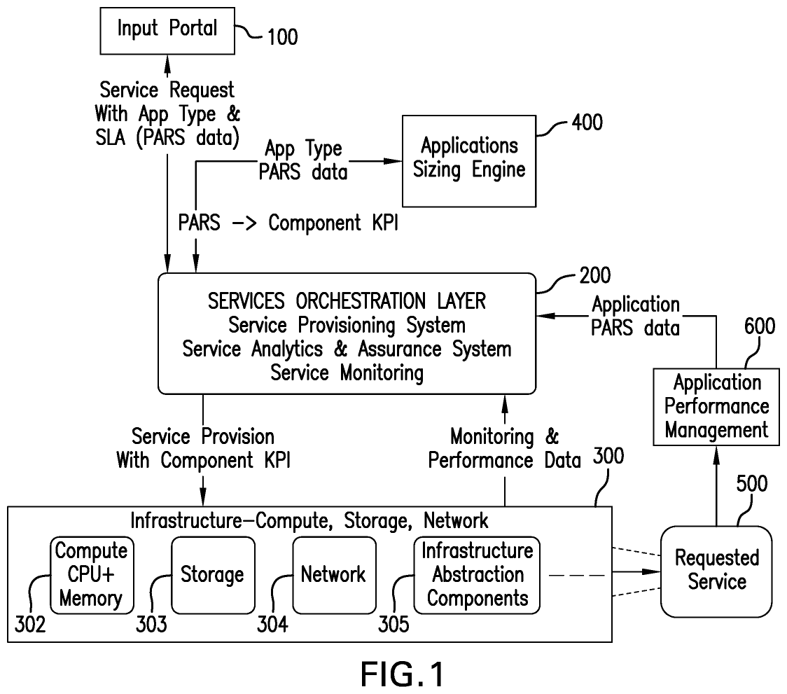

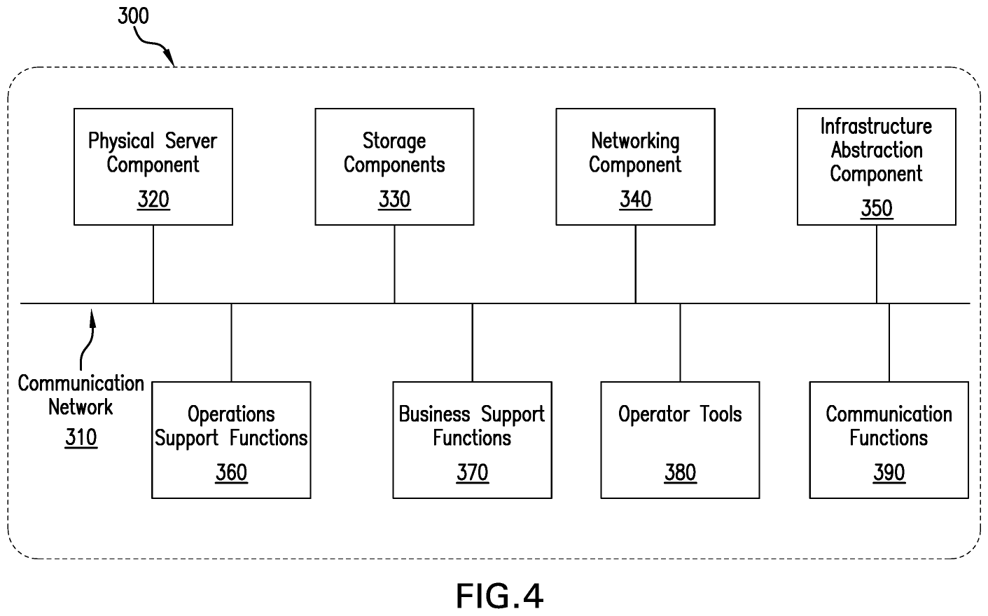

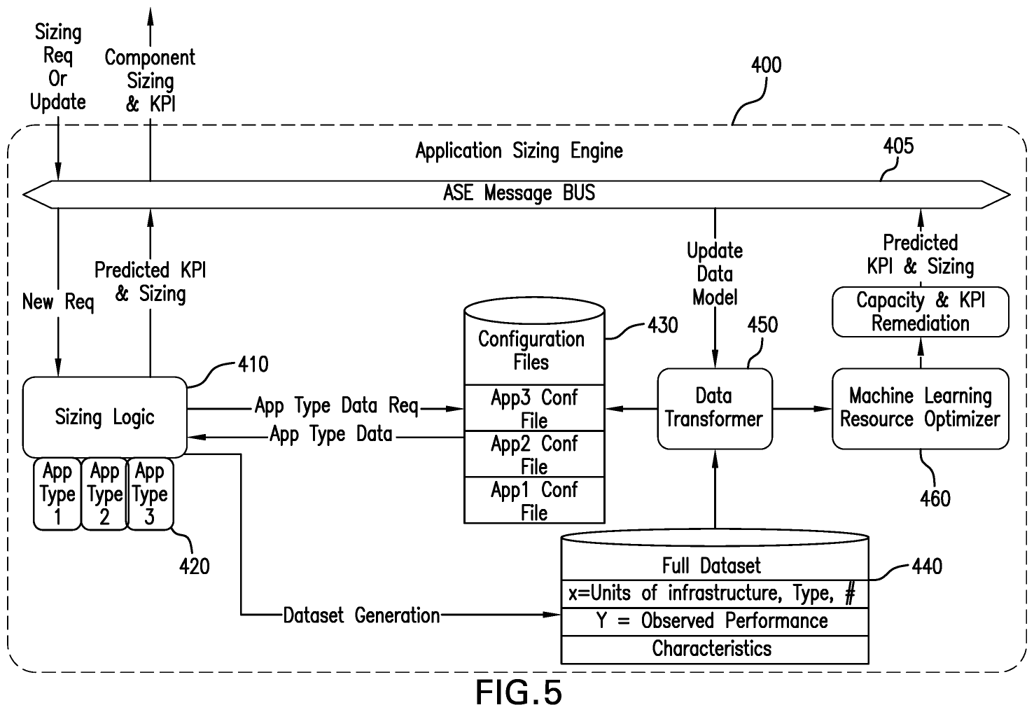

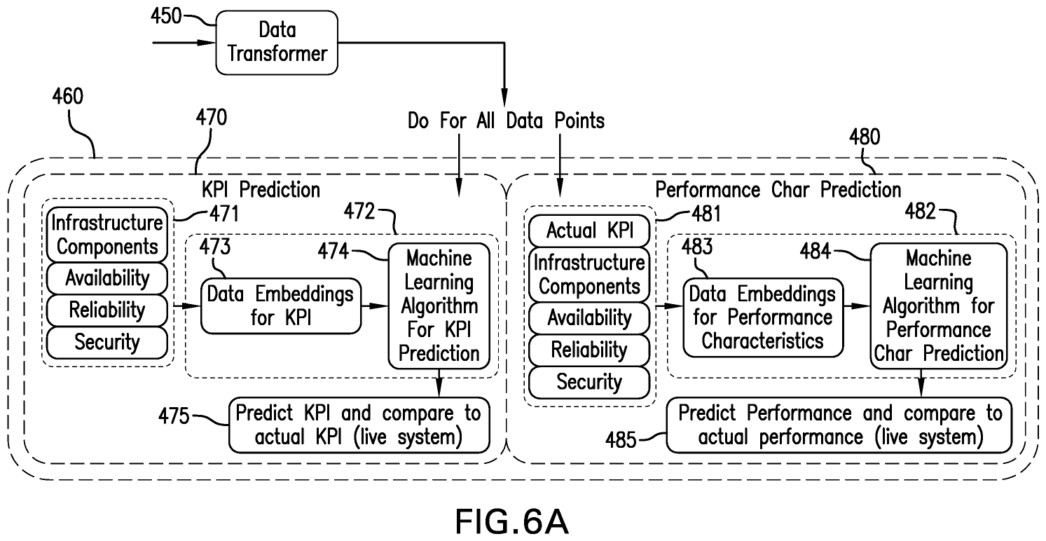

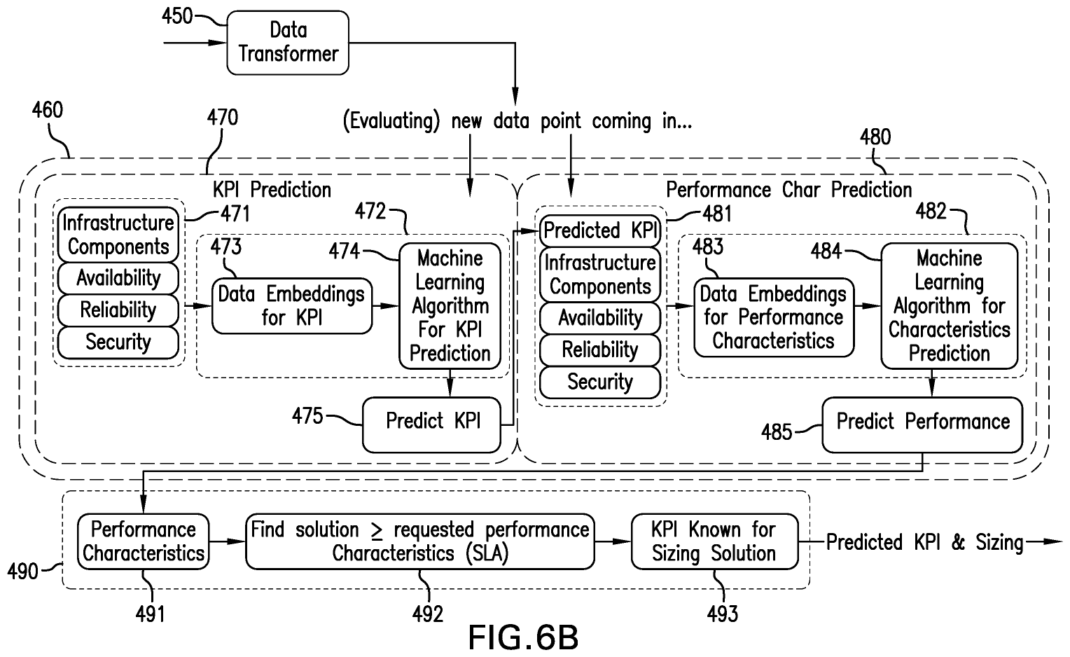

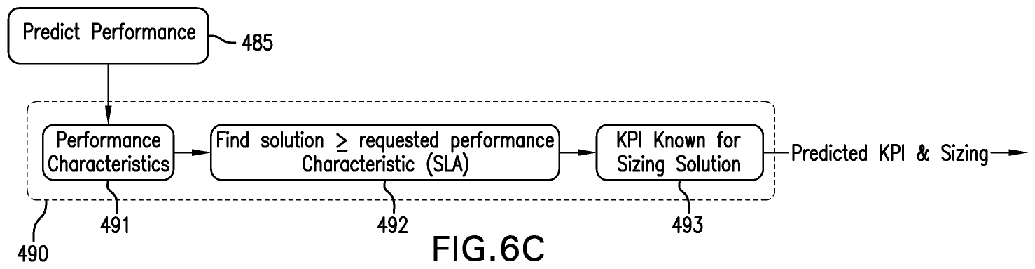

FIG. 1 shows the architecture of the Application Service Provisioning System and consists of following major components:
a. Block 100: The Input Portal where the user will input the intent for the application type required.
b. Block 200: The Service Orchestration system that Provisions, monitors, assures and remediates an application service delivered. In addition to these services the block also has other functions such as infrastructure registry and infrastructure services.
c. Block 300: Described in FIG. 4.
d. Block 400: The Application Sizing Engine which sizes the capacity and performance Key Performance Indicators (KPIs) of the components of the service, further described in FIGS. 5, 6a, 6b and 6c.
e. Block 500: The requested service itself, the requested service can be a bare metal server, a Virtual Machine running on a Hypervisor or a Container that hosts the required application.
f. Block 600: An external Application Performance Management (APM) software which would monitor the requested service to provide the observed performance KPIs. Block 600 can be a commercially available APM software provided by vendors such as Dynatrace, Cisco or New Relic.

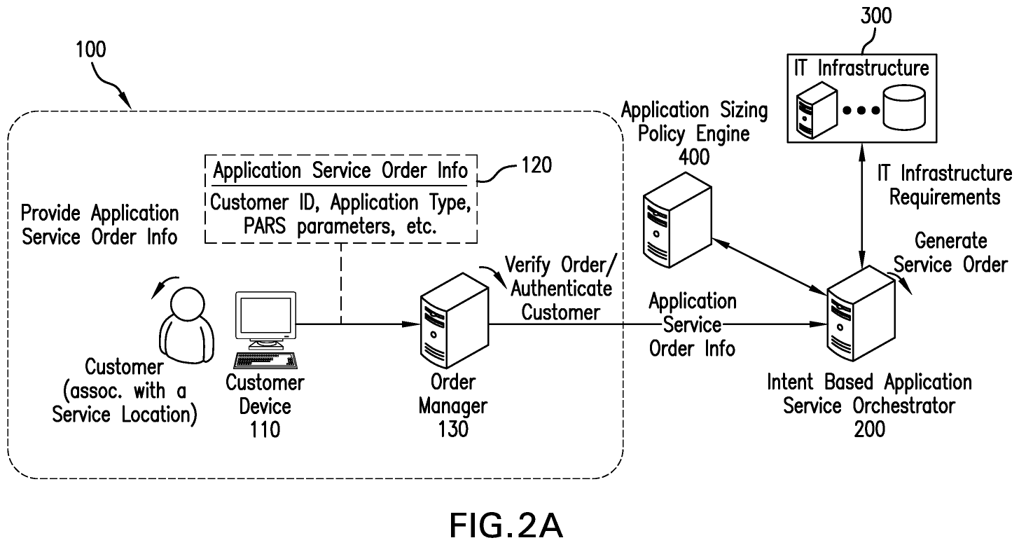

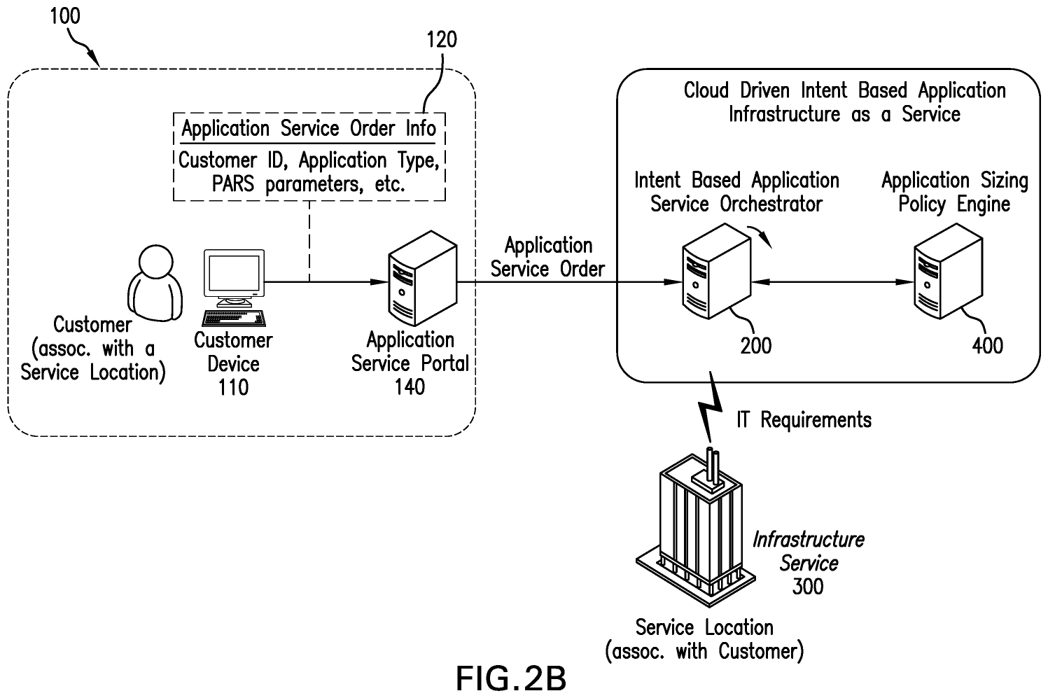

FIGS. 2a, 2b show the user input portal (block 100) according to exemplary embodiments of the disclosure. Block 100, containing blocks 110, 120, 130 and 140, allows the user to provide intent of the Infrastructure service required for a particular type of application.

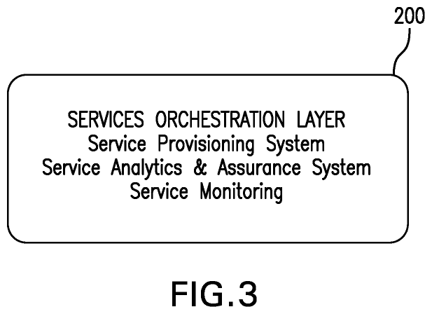

FIG. 3 shows the Service Orchestration System (block 200) according to exemplary embodiments of the disclosure.

FIG. 4 shows aspects of the infrastructure in the topology of the infrastructure as a service according to exemplary embodiments of the disclosed subject matter, including Block 300. Infrastructure may contain at least Blocks 310, 320, 330, and/or 340.
a Block 320: Compute—Physical compute components
b. Block 330: Storage—Physical storage components
c. Block 340: Network—Physical network components
d. Block 350: Infrastructure Abstraction Components
e. Block 360: Operations support functions needed to efficiently run the Infrastructure, viz. DNS, DHCP, NTP, Patch Management, etc.
Block 370: Business support functions needed to efficiently run the business, viz. CRM systems, billing systems, etc.
g. Block 380: Operator tools needed to efficiently run the infrastructure, viz. email, pager, messaging channels, help desk, ticketing systems, etc.
h. Block 390: Communications functions needed to communicate with the personnel managing the infrastructure, viz. phone, wireless communication devices, etc.
i. Block 300 will also contain any infrastructure component that is a component of the service needed to be delivered, and this can be extended to the physical attributes like power distribution units, Heating, Ventilation and Air Conditioning (HVAC) systems, etc.

FIG. 5 shows aspects of the Application Sizing Engine according to exemplary embodiments of the disclosed subject matter. The Application Sizing Engine (ASE) includes Block 400 of the topology of FIG. 1 containing Blocks 410, 420, 430, 440, 450, 460 and 470 performing the function of appropriately sizing the infrastructure that needs to be provisioned to as per the intent of the user.

FIG. 6A shows aspects of the ML based Resource Optimizer operating in a Learning Mode. The resource optimizer is training the data set in this mode of operation.

FIG. 6B shows aspects of the ML based Resource Optimizer operating in a Predict Mode. The resource optimizer predicts the correct component capacity and KPIs in this mode of operation.

FIG. 6C shows aspects of the Capacity and KPI Remediation according to exemplary embodiments of the disclosed subject matter. This consists of Block 490, 491, 492 and 493, based on the prediction provided by the Performance Characteristic Prediction module, predicts the new or changed capacity and its corresponding KPIs.

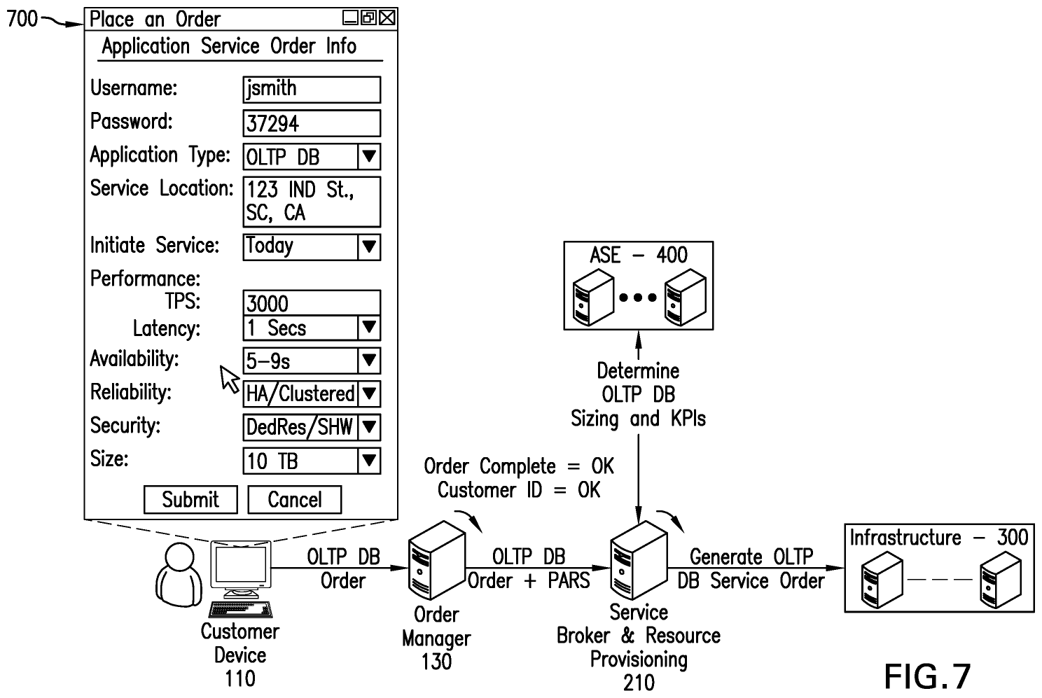

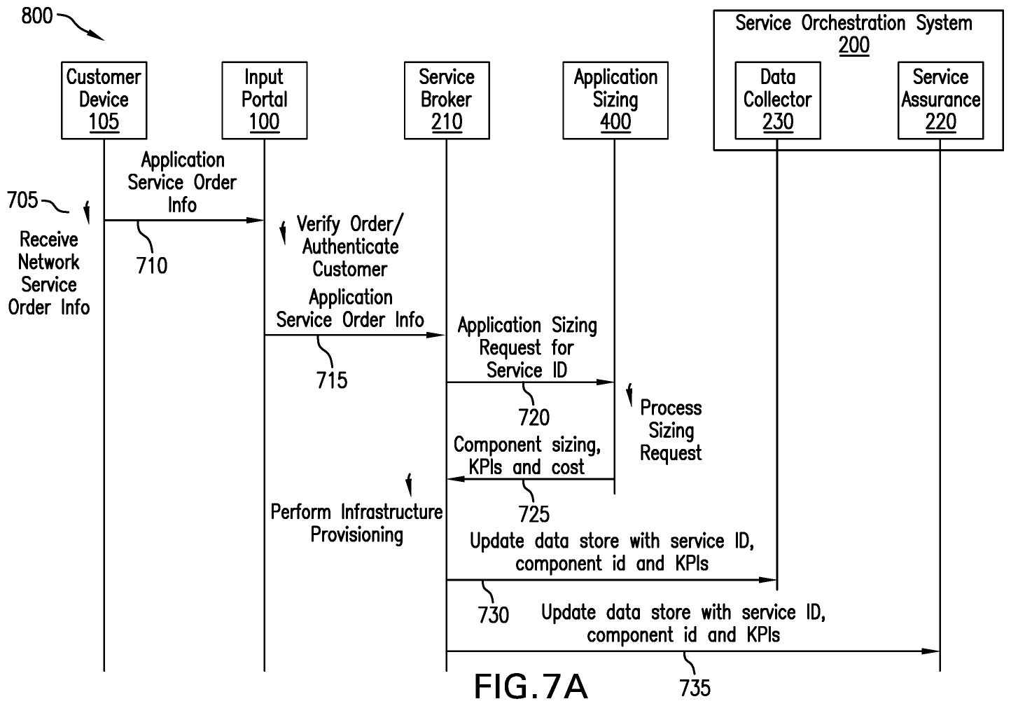

FIG. 7 outlines the input portal form for a given application type and outlines the different components that will be invoked to deliver the requested service.

FIG. 7a outlines the workflow from the input portal to the infrastructure to show how the requested service will be delivered.

Next is a description of the process of service provisioning to user (U). To accompany said description, there exists an example service provision outline below for an embodiment of the disclosed invention.

U will approach the user portal—Block 100—and request Infrastructure Service to be provisioned for an Online Transaction Processing Database (OLTP Database) with capacity of 10 terabytes. U requests that the infrastructure service for said application must meet certain P.A.R.S requirements outlined below:
a. Performance Characteristics—Transactions per Second: 3000; Number of concurrent transactions: 500; Transaction latency: ≤1 second (transaction should complete within one second)
b. Availability Characteristics—99.999% availability (5-9's)
c. Reliability Characteristics—High Availability Enabled
d. Security Characteristics—Dedicated resources, shared hardware

U will input said P.A.R. S. requirements establishing the SLA between U and SP on the user portal in Block 100. The P.A.R. S. characteristics established by U will be shared with the Intent Based Application Infrastructure as a Service Orchestration System—Block 200. Specifically, the said data will be transmitted to the Service Orchestration System. The Service Orchestration System will communicate the P.A.R.S. characteristics with the ASE—Block 400 to devise a possible solution that meets and adheres to the SLA. This solution involves providing the capacity and the KPIs of the individual components using one of the two methods described below:
a. In the event the particular application type is being deployed by Block 200 for the very first time, the ASE utilizes an already stored empirical model to provide the capacity and KPIs of the individual components
b. In the event that the particular application type has already been deployed by Block 200, then the ASE has already trained its data model for the ML algorithm and it will provide the capacity and KPIs for the individual components based on the current state and performance of the given infrastructure, Block 300 and specifically provision the compute, storage, network and Infrastructure abstraction components—Blocks 302, 303, 304, 305, etc. respectively.

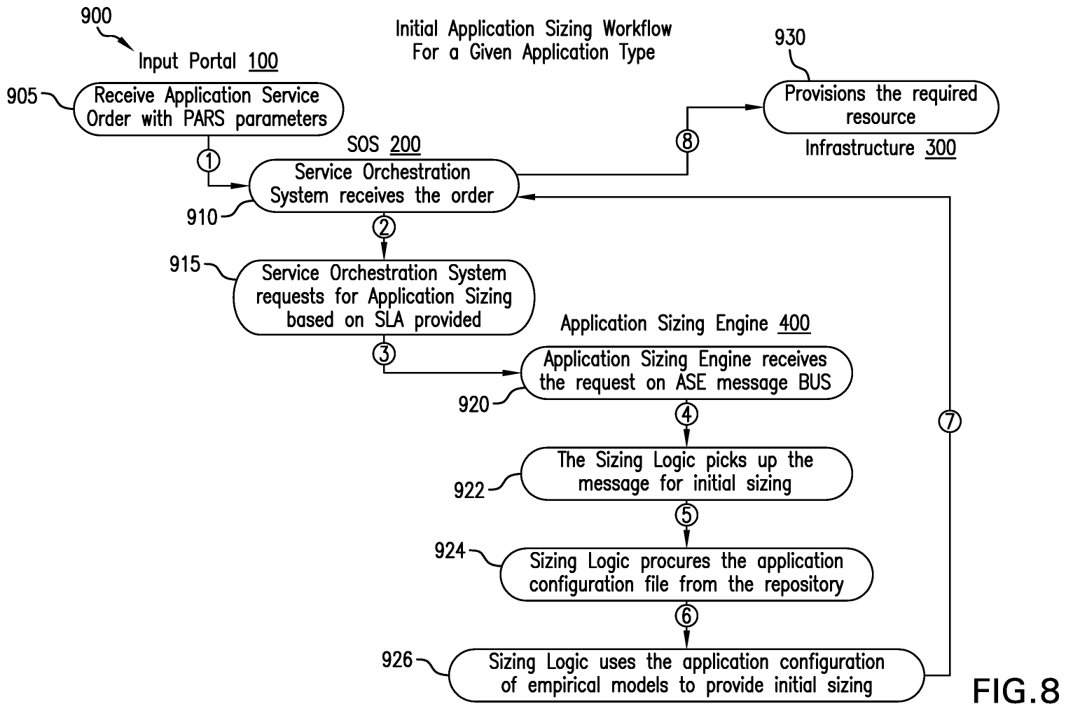

FIG. 8 depicts the workflow of how a particular application type will be delivered for the very first time on the infrastructure using empirical modeling done in advance of a Service Level Request. FIG. 8 describes the workflow that is followed by the Blocks 100, 200, 400 and 300 when a particular application type is being deployed for the very first time,

Block 200 receives the sizing and the KPIs of the required infrastructure components. Block 200 finds the appropriate component within the infrastructure and through the communication medium previously determined between the Service Orchestration System—Block 200 and the individual component. Once the component is configured as per the request, Block 200, the service orchestration system performs all the necessary tasks to ensure that the individual components are all configured to perform as a single application service entity.

The first time an application type is deployed the ASE will enter the learning mode, the inputs for its learning and training the ML algorithm are the KPIs being observed for the requested service components and Application Performance Management software or an operator manually entering the observed SLA of the requested service. The ASE uses these two inputs to compare and teach the ML algorithms of its previous empirical predictions and retrain the data set to a more accurate predictions based on real time inputs from the infrastructure in Block 300.

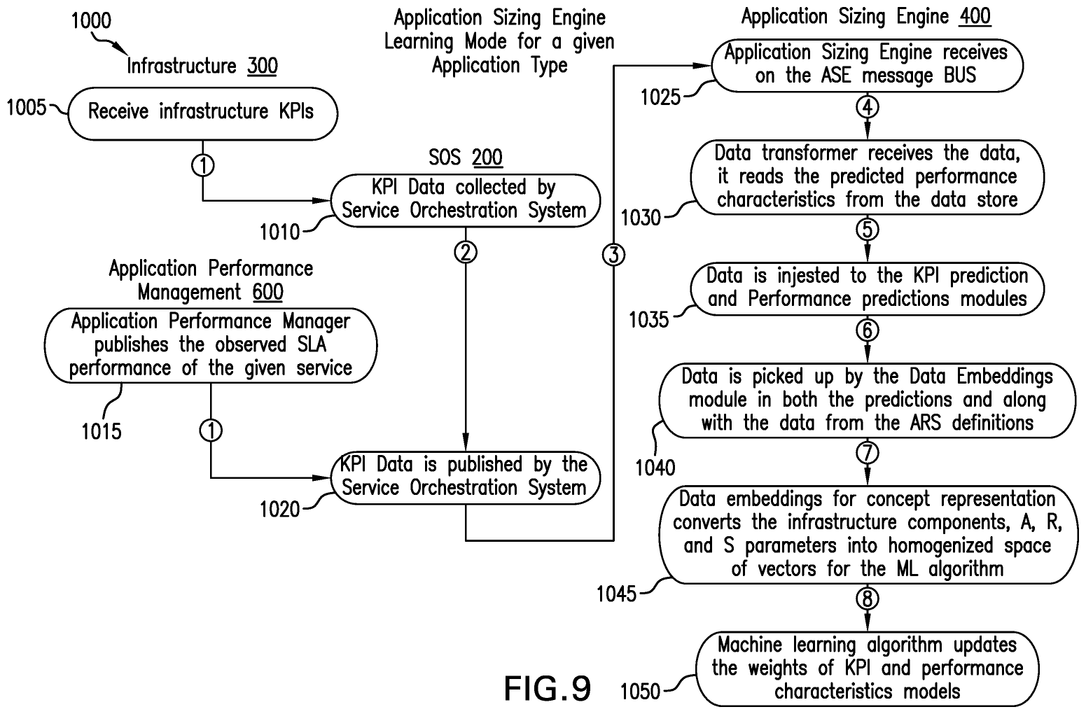

FIG. 9 describes the workflow that is followed to train the ML algorithms with real time data, which enables the ML algorithms to learn about the infrastructure and its behavior for a particular application type.

Once the ASE is trained with the data attributes of the current infrastructure, the ASE operates in two modes:
a. The mode in which it receives real time component KPIs and application performance data from Block 200 about the services of the particular application type it has just been trained on, and now operates to remediate the said requested service to operate at optimal capacity levels
b. The mode in which ASE provides a more accurate sizing of capacity and KPIs for a brand new requested services of the same application type

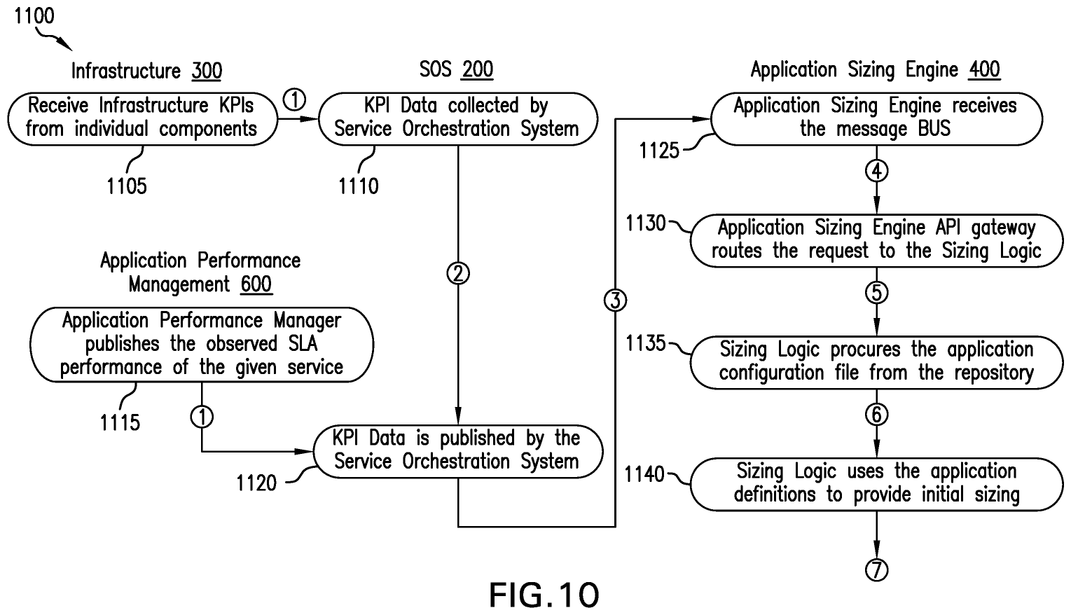

FIG. 10 depicts the workflow of the ASE's ML algorithms in the predict mode, which enables the ML engine to predict the corrections needed to the current sizing and KPI characteristics based on the performance of the current infrastructure for a particular application type.

FIG. 10 along with FIG. 6C highlights the workflow that is used by ASE to provide a recalculated component capacity and KPI for an already existing requested service and ensure that the resources are optimally utilized for a given application type.

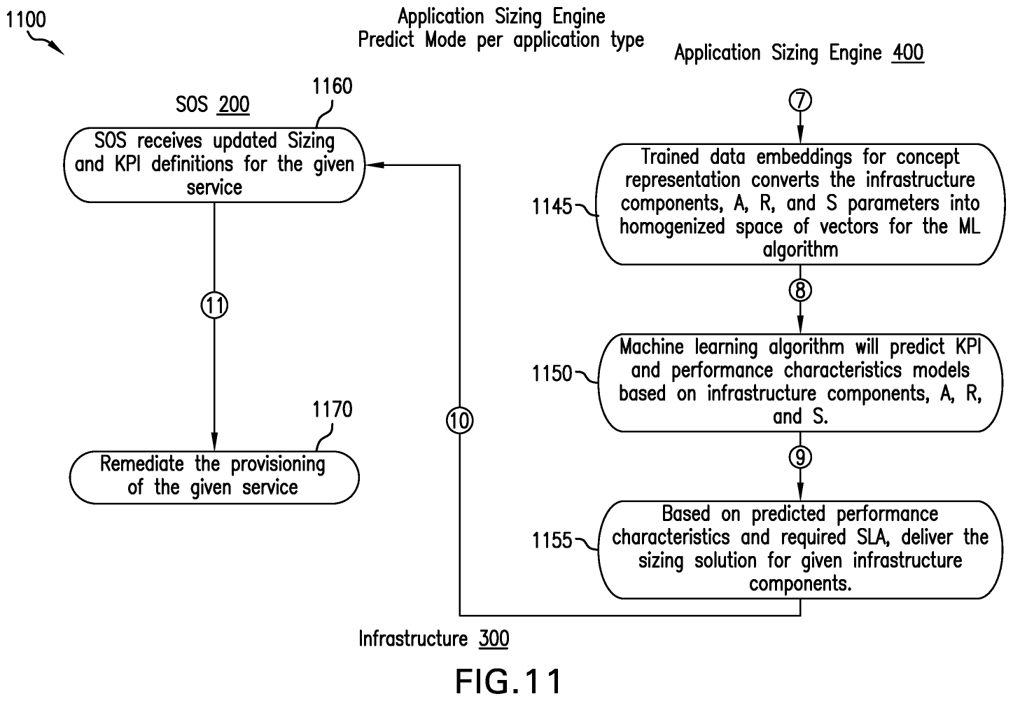

FIG. 11 depicts the workflow of the ASE which gets its recommendations from the ML algorithms and initiates Block 200 to take corrective action.

FIG. 11 shows the workflow for a new requested service to be deployed on the infrastructure for the given application type that has already been deployed at least once on the infrastructure.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, a combination of hardware and software and/or a particular Information Technology function such as compute, network or storage.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

We claim:

1. A method of sizing infrastructure for an application as a service, comprising:
receiving information associated with a request for service;
determining an amount of infrastructure to provide the service based on an empirical model;
determining the corresponding Key Performance Indicators (KPIs) for the infrastructure based on the empirical model; and
outputting the amount of infrastructure to a service orchestration system.

2. The method of claim 1, further comprising:
receiving first information associated with the key performance indicators (KPI) of the infrastructure components;
predicting the performance of the infrastructure based on the KPI;
receiving second information associated with observed performance of the infrastructure;
comparing the predicted performance based on the KPI with the observed performance;
converting the observed performance, availability, reliability and security parameters of the infrastructure into homogenized space vectors for a machine learning algorithm; and
updating the weights of the KPI and performance characteristics using the machine learning algorithm.

3. The method of claim 2, further comprising:
determining a sizing solution for an amount of infrastructure to provide the service based on the updated weights of the KPI and performance characteristics; and
outputting the sizing solution to the service orchestration system.

4. An apparatus for sizing infrastructure for an application as a service, comprising:
a memory; and
at least one processor coupled to the memory, the processor configured to:
receive information associated with a request for service;
determine an amount of infrastructure to provide the service based on an empirical model;
determine the corresponding Key Performance Indicators (KPIs) for the infrastructure based on the empirical model; and
output the amount of infrastructure to a service orchestration system.

5. The apparatus of claim 4, wherein the processor is further configured to receive first information associated with the key performance indicators (KPI) of the infrastructure components;
predict the performance of the infrastructure based on the KPI;
receive second information associated with observed performance of the infrastructure;
compare the predicted performance based on the KPI with the observed performance;
convert the observed performance, availability, reliability and security parameters of the infrastructure into homogenized space vectors for a machine learning algorithm; and
update the weights of the KPI and performance characteristics using the machine learning algorithm.

6. The apparatus of claim 5, wherein the processor is further configured to
determine a sizing solution for an amount of infrastructure to provide the service based on the updated weights of the KPI and performance characteristics; and
output the sizing solution to the service orchestration system.

7. A non-transitory computer readable medium having computer readable instructions stored thereon, that when executed by a computer cause at least one processor to:
receive information associated with a request for service;
determine an amount of infrastructure to provide the service based on an empirical model;
determine the corresponding Key Performance Indicators (KPIs) for the infrastructure based on the empirical model; and
output the amount of infrastructure to a service orchestration system.

8. The non-transitory computer readable medium of claim 7 wherein the computer readable instructions further cause at least one processor to:
receive first information associated with the key performance indicators (KPI) of the infrastructure components;
predict the performance of the infrastructure based on the KPI;
receive second information associated with observed performance of the infrastructure;
compare the predicted performance based on the KPI with the observed performance;
convert the observed performance, availability, reliability and security parameters of the infrastructure into homogenized space vectors for a machine learning algorithm; and
update the weights of the KPI and performance characteristics using the machine learning algorithm.

9. The non-transitory computer readable medium of claim 8 wherein the computer readable instructions further cause at least one processor to
determine a sizing solution for an amount of infrastructure to provide the service based on the updated weights of the KPI and performance characteristics; and
output the sizing solution to the service orchestration system.
